(19) United States
(12) Patent Application Publication
(10) Pub. No.: US 2009/0001624 A1
(43) Pub. Date: Jan. 1, 2009

(54) METHOD FOR PERFORMING THE CLAMPING FORCE RELAXATION IN A CLAMPING UNIT OF AN INJECTION MOLDING MACHINE

(75) Inventor: Christoph MEHLER, Langenargen (DE)

Correspondence Address: BROWDY AND NEIMARK, P.L.L.C.;624 NINTH STREET, NW, SUITE 300, WASHINGTON, DC, 20001-5303, US

(73) Assignee: Demag Ergotech GmbH, Schwaig (DE)

(21) Appl. No.: 12/164,723

(22) Filed: Jun. 30, 2008

(30) Foreign Application Priority Data
Jun. 28, 2007 (DE) 10 2007 029 977.1

(51) Int. Cl. B29C 45/80

(52) U.S. Cl. 264/40.5

(57) ABSTRACT

The present invention relates to a method for performing the clamping force relaxation in a clamping unit of an injection molding machine. During set-up of the injection molding process, one or more real pressure curves of the mold cavity pressure during the cooling phase are determined and a set-point curve is derived therefrom, which is stored in the machine control unit. In dependence upon the product properties and material properties the seal point is established on the pressure curve. Furthermore, the relaxation speed of the clamping pressure of the clamping unit is determined and it is specified, in dependence upon the seal point and relaxation speed, at which pressure on the reference curve the clamping force relaxation is started. During the cyclic operation of the injection molding machine the actual pressure during the cooling phase is determined and the pressure force increase is performed when the actual pressure has reached the set-point pressure that was specified during set-up.

### BACKGROUND OF THE INVENTION

1. Field of the Invention

The present invention relates to a method for performing the clamping force relaxation in a clamping unit of an injection molding machine.

2. Background Art

The operational efficiency of an injection molding process is significantly guided by the cycle time. The goal in a cost effective production of a molded article is to reduce to a minimum the cycle time that is needed for this process. This allows the highest possible output rate to be achieved.

The process steps, such as tool and aggregate movements, injection, pressure holding, cooling and metering are fixed components of every cycle. The individual steps occur partly in succession, partly overlapping in time. For example, the cooling time, per its definition, starts with the beginning of the injection process. It includes the complete pressure holding phase and ultimately ends with the opening lift of the tool for demolding of the finished molded article. After the pressure holding time the so-called residual cooling time starts. The cooling time of an injection-molded article usually amounts to over ⅔ of the entire cycle time. It increases with the square of the molded-article wall thickness. As a rule, the cooling time extends past the pressure holding time, since the molded article generally has not yet sufficiently cooled off by the completion of the pressure holding phase and, therefore, is not yet sufficiently dimensionally stable for demolding. The opening of the tool marks the end of the cooling time.

The cooling time, accordingly, is generally divided into the phases injection time, pressure holding time and residual cooing time. Determining the total cooling time requires the individual phases to be estimated as closely as possible. The pressure holding time can be estimated by determining the gate seal time. The gate seal time marks the moment up to which additional material can still be forced into the cavity by holding the pressure, i.e., until the sprue or gate of the molded article has solidified. As a rule, approximately 30% of the cooling time are enough for the gate to freeze. This particularly depends on the material, however, and on the geometry/thickness of the molded article. Once the gate seal time has been reached, it is no longer possible to effectively maintain the holding pressure.

When the pressure in the tool has dropped to ambient pressure during the molded-article formation process the molded article usually cannot yet be removed from the mold, due to its insufficient dimensional stability. Demolding of a thermoplastic article can take place only at a low temperature level so that the molded article must continue to be cooled down in the mold cavity until then. However, after ambient pressure has been reached, it is no longer necessary to maintain the clamping pressure.

The additionally needed retention time in the tool after the seal point has been reached, until the demolding, is called residual cooling time. The residual cooling time thus results from the total cooling time minus the pressure holding time and injection time. It begins after the pressure holding phase has ended and is customarily entered into the injection molding machines as a setting parameter.

In order to increase the operational efficiency of the production, one must clarify whether the injection molding cycle offers time reserves by which the production process can be shortened.

In this context it has been found that the clamping force relaxation takes up some time, in dependence upon the design and operation of the clamping unit. This means that if one starts the clamping force relaxation only once the ambient pressure has been reached in the cavity, and starting at which it is no longer necessary to maintain the clamping pressure, valuable time is lost.

It is already known to use the surface temperature to specify the optimum cooling period, so as to be able to open the tool after a certain temperature value has been reached. However, one still continues to depend on the setting and estimate by the machine setter for the total cycle time.

### SUMMARY OF THE INVENTION

The present invention has as its object to improve a method for performing the clamping-force relaxation in a clamping unit of an injection molding machine in such a way that the cycle time is optimized further.

This object is met according to the inventive method for performing the clamping force relaxation in a clamping unit of an injection molding machine, wherein
during set-up of the injection molding process
   one or more real pressure curves of the mold cavity pressure during the cooling phase are determined, and a set-point curve derived therefrom is stored in the machine control unit,
   in dependence upon the product properties and material properties, the seal point is established on the pressure curve,
   the relaxation speed of the clamping pressure of the clamping unit is determined,
   it is specified, in dependence upon the seal point and the relaxation speed, at which pressure on the reference curve the clamping-force pressure relaxation is started, and
during the cyclic operation of the injection molding machine
   the actual pressure during the cooling phase is determined, and
   the pressure force relaxation is performed when the actual pressure has reached the set-point pressure that was specified during set-up.

In this context, one idea of the present invention consists in that the time that is needed by the clamping pressure relaxation process is incorporated into the calculation, and to start the clamping pressure relaxation accordingly in advance so that the time that is needed for the clamping pressure relaxation process is not unnecessarily lost. However, the clamping pressure relaxation cannot be started arbitrarily. On one hand, of course, the speed or duration must be known that is needed by the clamping force relaxation process (gating of valves, relieving of the pressure in the lines, start-up of electric motors, etc.). On the other hand, the permission of the initiation of the clamping-pressure relaxation also depends on the product properties and material properties; for example the cooling time for thick material increases with the square, so that the moment for the clamping force relaxation depends to a large degree on the product geometry. When setting up an injection molding process, pressure curves are determined in accordance with the invention by means of a cavity pressure sensor that is placed at a suitable location inside the tool. From these pressure curves a set-point curve is derived and stored in the machine control unit. In dependence upon the product properties and material properties the seal point, or point after which the clamping pressure is no longer required, is determined. This point may be the 1-bar line, for instance, since no more force is then exerted by the product onto the tool than the usual air pressure. By incorporating the relaxation speed of the clamping pressure a pressure can then be determined on the set-point or reference curve at which the clamping force relaxation can be started.

During the cyclic operation of the injection molding machine the actual pressure is then continually determined by the cavity pressure sensor during the cooling phase, and the clamping force relaxation is performed specifically when the actual pressure has reached the value that was marked on the set-point pressure curve. By determining the seal point or pressure point starting at which a clamping pressure no longer needs to be present, the earliest possible moment can be determined for a clamping force relaxation without loss of quality.

The stored set-point curve, reference curve, or also master curve thus serves for regulating the clamping force relaxation. It is oriented on the measured actual value and the cavity-pressure relaxation speed on which it was based. The relaxation speed of the clamping pressure can specifically also be seen as a time derivative of the pressure signal, wherein the pressure relaxation towards the end of the cooling time approximates a linear progression. This pressure gradient, which also is material-dependent, can flow into the specification of the initiation of the clamping force relaxation as well.

All in all, the clamping force relaxation is thus initiated before the 1-bar line is reached. This saves additional cycle time.

This correlation is clarified again in the appended figures.

### BRIEF DESCRIPTION OF THE DRAWINGS

FIG. 1 shows a pressure diagram for the closing force of a clamping unit during the closed phase, and

FIG. 2 shows a pressure curve of the tool cavity pressure during the cooling phase.

### DESCRIPTION OF THE PREFERRED EMBODIMENT

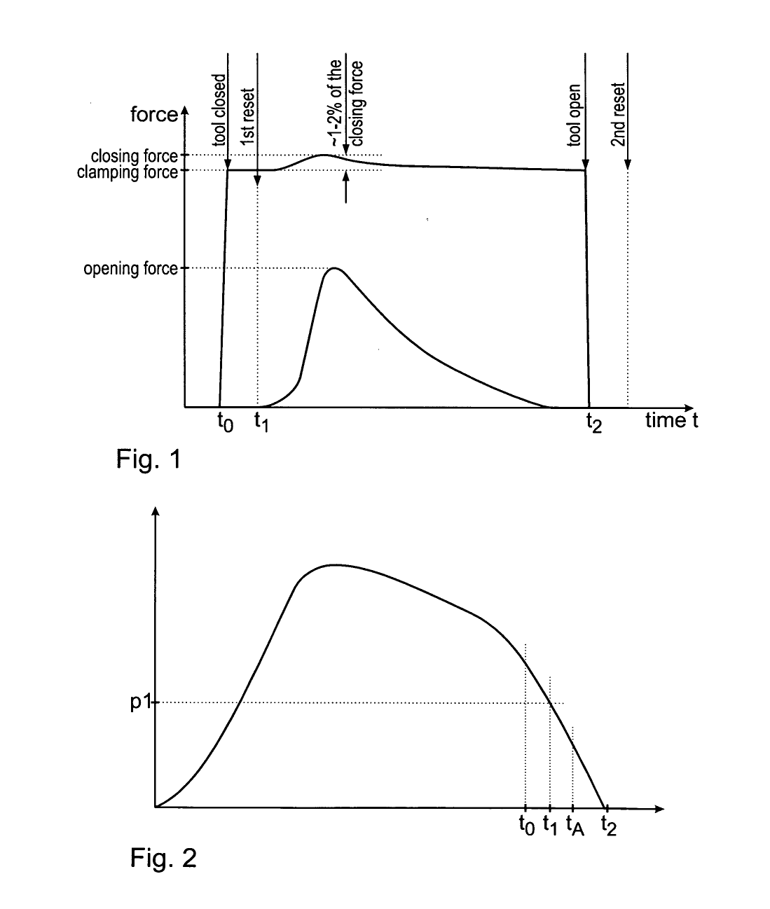

From FIG. 1 it is apparent that the tool is being closed at a moment to and at this moment the (clamping) force increases strongly. At the moment t₁ the injection process is started. Starting with this moment, the force with which the clamping unit is held closed increases, until the so-called mold opening force is reached. (The bottom curve in FIG. 1 shows, in an enlarged view, the shape of the pressure curve over the clamping force.) Altogether, the closing force adds itself to the clamping force. The closing force, as a rule, amounts to 1-2% of the clamping force. In the bottom portion of FIG. 1, where the closing force is shown in an enlarged view, one can see that the closing force starts to drop continually after a maximum point. At the moment t₂ the tool is then opened.

In order to now, in accordance with the invention, optimally design the cycle time, the clamping force relaxation is started already prior to reaching the so-called 1-bar line. In FIG. 2, the 1-bar line is marked with p1. The pressure curve of the tool cavity pressure reaches the 1-bar line at the moment t₁. Even prior to the moment t₁, namely at the moment to, the clamping force relaxation is being started. This moment depends on the moment t₁, on the pressure gradient of the tool cavity pressure, which is nearly linear in the end phase, and on the duration for the pressure relaxation. At the moment t_{A}, the tool could then be opened. At the moment t₂ the tool is then in fact opened.

Altogether, in the interval of the cooling phase, the cycle time can thus be reduced by means of a clamping force relaxation that is started in advance, and the efficiency of an injection molding process can thus be increased.

What is claimed is:

1. A method for performing the clamping force relaxation in a clamping unit of an injection molding machine, wherein
during set-up of the injection molding process
one or more real pressure curves of the mold cavity pressure during the cooling phase are determined, and a set-point curve derived therefrom is stored in the machine control unit,
in dependence upon the product properties and material properties, the seal point is established on the pressure curve,
the relaxation speed of the clamping pressure of the clamping unit is determined,
it is specified, in dependence upon the seal point and the relaxation speed, at which pressure on the reference curve the clamping-force pressure relaxation is started, and
during the cyclic operation of the injection molding machine
the actual pressure during the cooling phase is determined, and
the pressure force relaxation is performed when the actual pressure has reached the set-point pressure that was specified during set-up.

2. A method according to claim 1,
wherein in the determination of the relaxation speed of the pressure, the pressure gradient is used.

3. A method according to claim 1,
wherein in the clamping pressure relaxation, it is taken into account when the 1-bar pressure line has been reached.

4. A method according to claim 3,
wherein a linear pressure relaxation toward the end of the cooling time is used in the specification and calculation.

5. A method according to claim 1,
wherein the seal pressure is determined with the aid of a stored mathematical formula, in which defined parameters, such as product size, maximum material thickness and type of material are entered.
